(19) United States
(12) Patent Application Publication
(10) Pub. No.: US 2022/0237827 A1
(43) Pub. Date: Jul. 28, 2022

(54) DISPLAY METHOD AND DISPLAY SYSTEM

(71) Applicant: SEIKO EPSON CORPORATION, Tokyo (JP)

(72) Inventors: Kazuyoshi KITABAYASHI, Azumino-shi (JP); Kazue SUNOHARA, Matsumoto-shi (JP)

(73) Assignee: SEIKO EPSON CORPORATION, Tokyo (JP)

(21) Appl. No.: 17/584,689

(22) Filed: Jan. 26, 2022

(30) Foreign Application Priority Data
Jan. 27, 2021 (JP) 2021-011093

(51) Int. Cl. G06T 11/00

(52) U.S. Cl. CPC G06T 11/00

(57) ABSTRACT

The display method includes the steps of obtaining a target image showing a target region including a surface in a real space having the target region and a display, and displaying a first simulation image on the display, the first simulation image being obtained by superimposing a first display image on the target image, the first display image being obtained by viewing an image from a second position which corresponds to a position of the display in the real space, the image being projected on a virtual plane, which is located at a first position corresponding to a position of the surface in the real space and corresponds to the surface, from a virtual projector when a relative position of the virtual projector to the second position is fixed in a virtual space having the virtual plane and the virtual projector.

The present application is based on, and claims priority from JP Application Serial Number 2021-011093, filed Jan. 27, 2021, the disclosure of which is hereby incorporated by reference herein in its entirety.

### BACKGROUND

### 1. Technical Field

The present disclosure relates to a display method and a display system.

### 2. Related Art

JP-A-2014-56044 discloses an image projection system which displays candidates of a project ion layout diagram. The candidates of the projection layout diagram each show a projector, and a projection image projected by the projector. In the candidates of the projection layout diagram, candidates of arrangement positions of the projector and the projection image are stored in a database server.

As described above, in the candidates of the projection layout diagram stored in the database server, the user selects the arrangement positions of the projector and the projection image from the candidates thus stored. Therefore, when the user tries to decide an installation position of the projector while changing the positional relationship between the projector and the projection image, the candidates do not make much contribution to the decision of the installation position of the projector by the user, and are low in convenience.

### SUMMARY

A display method according to an aspect of the present disclosure includes the steps of obtaining a target image showing a target region including a surface in a real space having the target region and a display, and displaying a first simulation image on the display, the first simulation image being obtained by superimposing a first display image on the target image, the first display image being an image obtained by viewing an image from a second position which corresponds to a position of the display in the real space, the image being projected on a virtual plane, which is located at a first position corresponding to a position of the surface in the real space and corresponds to the surface, from a virtual projector when a relative position of the virtual projector to the second position is fixed in a virtual space having the virtual plane and the virtual projector.

A display system according to another aspect of the present disclosure includes a camera, a display, and at least one processor, wherein the at least one processor executes the steps of obtaining a target image showing a target region including a surface in a real space having the target region and the display using the camera, and making the display display a first simulation image, the first simulation image being obtained by superimposing a first display image on the target image, the first display image being an image obtained by viewing an image from a second position which corresponds to a position of the display in the real space, the image being projected on a virtual plane, which is located at a first position corresponding to a position of the surface in the real space and corresponds to the surface, from a virtual projector when a relative position of the virtual projector to the second position is fixed in a virtual space having the virtual plane and the virtual projector.

### BRIEF DESCRIPTION OF THE DRAWINGS

FIG. 1 is a diagram showing an information processing device 1.

FIG. 2 is a diagram showing a front surface 1a of the information processing device 1.

FIG. 3 is a diagram showing a back surface 1b of the information processing device 1.

FIG. 4 is a diagram showing an example of a target image H1.

FIG. 5 is a diagram showing an example of the information processing device 1.

FIG. 6 is a diagram showing an example of a virtual space VS.

FIG. 7 is a flowchart for explaining recognition of a wall E1.

FIG. 8 is a flowchart for explaining display of a first simulation image G1.

FIG. 9 is a diagram showing an example of an icon i displayed on a touch panel 12.

FIG. 10 is a diagram showing an example of a first guide image t1.

FIG. 11 is a diagram showing an example of the information processing device 1 displaying the target image H1.

FIG. 12 is a diagram showing an example of an image u1.

FIG. 13 is a diagram showing an example of an image u2.

FIG. 14 is a diagram showing an example of an image u3.

FIG. 15 is a diagram showing a situation in which the information processing device 1 is shaken by the user.

FIG. 16 is a diagram showing an example of an image u4.

FIG. 17 is a diagram showing another example of the image u4.

FIG. 18 is a diagram showing still another example of the image u4.

FIG. 19 is a diagram showing still another example of the image u4.

FIG. 20 is a diagram showing still another example of the image u4.

FIG. 21 is a diagram showing an example of an image u5.

FIG. 22 is a diagram showing another example of the image u5.

FIG. 23 is a diagram showing still another example of the image u5.

FIG. 24 is a diagram showing still another example of the image u5.

FIG. 25 is a diagram showing still another example of the image u5.

FIG. 26 is a diagram showing an example of a menu image v4.

FIG. 27 is a diagram showing an example of image candidates v8.

FIG. 28 is a diagram showing an example of the first simulation image G1.

FIG. 29 is a diagram showing an example of a second simulation image y1.

FIG. 30 is a diagram for explaining a subjective mode.

FIG. 31 is a diagram for explaining an overview mode.

FIG. 32 is a diagram showing an example of a second simulation image y1 including an image y3.

FIG. 33 is a diagram for explaining an example of a keystone distortion correction in a projection image F1.

FIG. 34 is a diagram showing an example of an image u8.

### DESCRIPTION OF AN EXEMPLARY EMBODIMENT

### A: First Embodiment

### A1: Outline of Information Processing Device 1

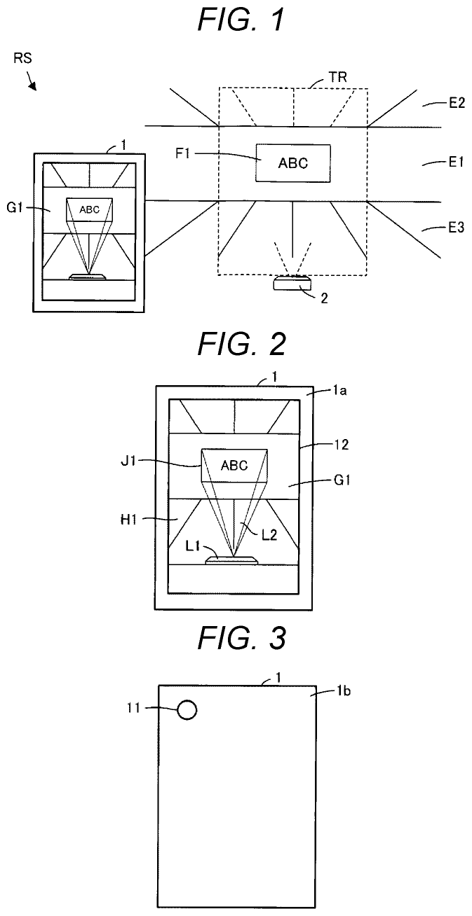

FIG. 1 is a diagram showing an information processing device 1. The information processing device 1 is a smartphone. The information processing device 1 is not limited to the smartphone, but can also be, for example, a tablet with a camera, a laptop PC (Personal Computer) with a camera, or a laptop PC to which a camera is coupled. The information processing device 1 is an example of a display system. The information processing device 1 is located in a real space RS.

The real space RS includes a projector 2, a wall E1, a ceiling E2, and a floor E3 in addition to the information processing device 1. The position of the projector 2 in the real space RS is not limited to the position shown in FIG. 1, but can arbitrarily be changed.

The wall E1 is a vertical plane. The wall E1 is not limited to the vertical plane, but is sufficiently a plane crossing a horizontal plane. The wall E1 is an inside wall of a building. The wall E1 is not limited to the inside wall of the building, but can be, for example, an outside wall of the building. At least a part of the wall E1 is an example of a plane. The plane is not limited to at least a part of the wall E1, but can also be, for example, at least a part of the ceiling E2, at least a part of the floor E3, a screen, a whiteboard, or a door. The plane is included in a target region TR.

The target region TR is included in the real space RS. The position of the target region TR in the real space RS is not limited to the position shown in FIG. 1, but can arbitrarily be changed.

The projector 2 projects a projection image F1 on the wall E1 using light. The information processing device 1 displays a first simulation image G1 related to an appearance of the projection image F1.

The information processing device 1 includes a front surface 1a, a back surface 1b, a camera 11, and a touch panel 12. FIG. 2 is a diagram showing the front surface 1a of the information processing device 1. FIG. 3 is a diagram showing the back surface 1b of the information processing device 1.

The camera 11 is located on the back surface 1b of the information processing device 1. The camera 11 takes an image of an imaging region. The imaging region of the camera 11 moves in accordance with a movement of the information processing device 1.

The imaging region of the camera 11 is used as the target region TR. Therefore, the target region TR moves in accordance with a movement of the information processing device 1. The camera 11 takes the image of the target region TR in the state in which the projector 2 does not project the projection image F1 to thereby generate a target image H1 showing the target region TR. The target image H1 showing the target region TR means an image showing an object existing in the target region TR.

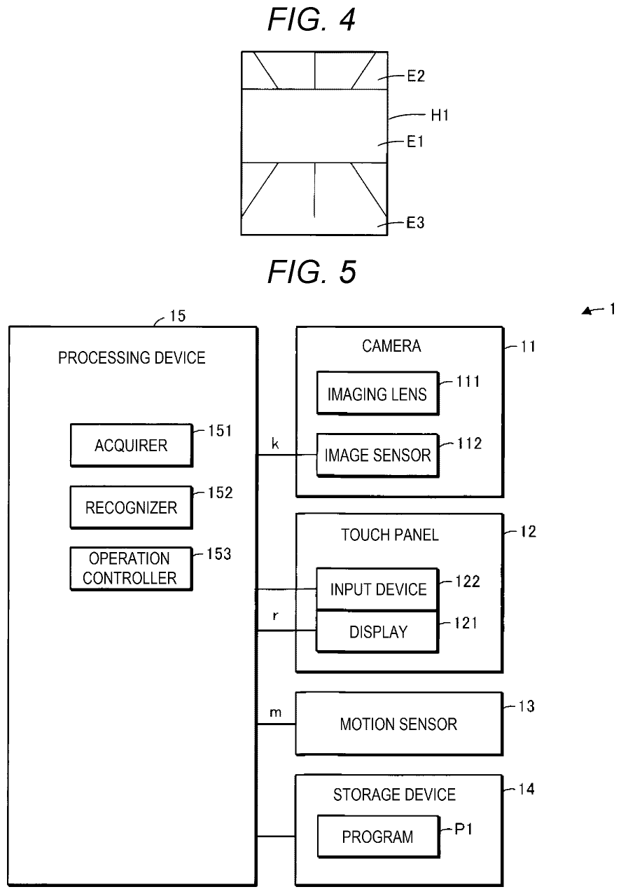

FIG. 4 is a diagram showing an example of the target image H1. The target image H1 shows the wall E1, the ceiling E2, and the floor E3.

As shown in FIG. 2, the touch panel 12 is located on the front surface 1a of the information processing device 1. The touch panel 12 is an example of the display. The touch panel 12 displays the first simulation image G1.

The first simulation image G1 is an image obtained by superimposing a sample image J1 on the target image H1. The sample image J1 is an example of a first display image. An aspect ratio of the sample image J1 is equal to an aspect ratio of the projection image F1. The sample image J1 is an image corresponding to the projection image F1. The sample image J1 shows, for example, the projection image F1. The sample image J1 can be an image different from the projection image F1 such as an image obtained by monochromating the projection image F1. The sample image J1 has predetermined transmittance. The transmittance of the sample image J1 can be variable.

The first simulation image G1 includes a projector image L1. The projector image L1 is an image showing a projector. The shape of the projector shown in the projector image L1 is the same as the shape of the projector 2. The shape of the projector shown in the projector image L1 can be different from the shape of the projector 2. The projector image L1 has predetermined transmittance. The transmittance of the projector image L1 can be variable.

The first simulation image G1 further includes a path image L2. The path image L2 is an image showing a light path used when the projector 2 projects the projection image F1. The path image L2 is also an image showing a light path virtually used when a virtual projector C4 corresponding to the projector 2 projects an image corresponding to the projection image F1. The virtual projector C4 will be described later. The path image L2 has predetermined transmittance. The transmittance of the path image L2 can be variable.

The first simulation image G1 is not required to include at least one of the projector image L1 and the path image L2.

### A2: Example of Information Processing Device 1

FIG. 5 is a diagram showing an example of the information processing device 1. The information processing device 1 includes the camera 11, the touch panel 12, a motion sensor 13, a storage device 14, and a processing device 15.

The camera 11 includes an imaging lens 111 and an image sensor 112.

The imaging lens 111 forms an optical image on the image sensor 112. The imaging lens 111 forms the target image H1 representing the target region TR on the image sensor 112.

The image sensor 112 is a CCD (Charge Coupled Device) image sensor. The image sensor 112 is not limited to the CCD image sensor, but can also be, for example, a CMOS (Complementary Metal Oxide Semiconductor) image sensor. The image sensor 112 generates imaging data k based on the optical image formed on the image sensor 112. For example, the image sensor 112 generates imaging data kt representing the target image H1 based on the target image H1 formed by the imaging lens 111. The imaging data kt is an example of the imaging data k.

The touch panel 12 includes a display 121 and an input device 122. The display 121 displays a variety of images. The input device 122 receives a variety of instructions.

The motion sensor 13 includes an acceleration sensor and a gyro sensor. The motion sensor 13 detects a motion of the information processing device 1. For example, the motion sensor 13 detects the motion of the information processing device 1 moved by the user. The motion of the information processing device 1 is represented by at least a moving distance of the information processing device 1, an amount of rotation of the information processing device 1, and a direction of the information processing device 1. The motion sensor 13 generates motion data m representing the motion of the information processing device 1.

The storage device 14 is a recording medium which can be read by the processing device 15. The storage device 14 includes, for example, a nonvolatile memory and a volatile memory. The nonvolatile memory is one of, for example, a ROM (Read Only Memory), an EPROM (Erasable Programmable Read Only Memory), and an EEPROM (Electrically Erasable Programmable Read Only Memory). The volatile memory is, for example, a RAM (Random Access Memory). The storage device 14 stores a program P1 and a variety of types of data. The program P1 is, for example, an application program. The program P1 is provided to the information processing device 1 from a server not shown. The program P1 can be stored in advance in the storage device 14.

The processing device 15 is formed of a signal CPU (Central Processing Unit) or a plurality of CPUs. The single CPU or the plurality of CPUs is an example of a single processor or a plurality of processors. The processor is an example of a processor set forth in the appended claims. Each of the CPU and the processor is an example of a computer.

The processing device 15 retrieves the program P1 from the storage device 14. The processing device 15 executes the program P1 to thereby function as an acquirer 151, a recognizer 152, and an operation controller 153.

It is possible for the processing device 15 to function as the acquirer 151 and the operation controller 153 by executing the program P1, and function as the recognizer 152 by executing a program different from the program P1. In this case, the program different from the program. P1 is stored in the storage device 14, and the processing device 15 retrieves the program different from the program P1 from the storage device 14.

Each of the acquirer 151, the recognizer 152, and the operation controller 153 can be realized by a circuit such as a DSP (Digital Signal Processor), an ASIC (Application Specific Integrated Circuit), a PLD (Programmable Logic Device), or an FPGA (Field Programmable Gate Array).

The acquirer 151 obtains the target image H1 showing the target region TR. For example, the acquirer 151 obtains the imaging data kt representing the target image H1 from the camera 11 to thereby obtain the target image H1. Further, the acquirer 151 obtains the motion data m from the motion sensor 13.

The recognizer 152 obtains the imaging data kt and the motion data m from the acquirer 151. The recognizer 152 executes three-dimensional measurement with respect to an object existing in the target region TR based on the imaging data kt and the motion data m.

The recognizer 152 executes the three-dimensional measurement in the following manner in the situation in which the information processing device 1 is moved from a first point to a second point while the camera 11 is imaging the wall E1.

The recognizer 152 obtains motion data ms from the acquirer 151. The motion data ms corresponds to the motion data m which is generated by the motion sensor 13 in the situation in which the information processing device 1 is moved from the first point to the second point while the camera 11 is imaging the wall E1. The recognizer 152 decides the distance from the first point to the second point as the base line length based on the motion data ms. The base line length is also referred to as a length of a base line.

The recognizer 152 obtains first imaging data k1 and second imaging data k2 from the acquirer 151. The first imaging data k1 corresponds to the imaging data kt which is generated by the camera 11 when the information processing device 1 is located at the first point. The second imaging data k2 corresponds to the imaging data kt which is generated by the camera 11 when the information processing device 1 is located at the second point. Each of the first imaging data k1 and the second imaging data k2 represents at least the wall E1.

The recognizer 152 executes the triangulation using the base line length, the first imaging data k1, and the second imaging data k2 to thereby execute the three-dimensional measurement.

The result of the three-dimensional measurement expresses the shape of the object existing in the target region TR using three-dimensional coordinates. The position of the camera 11 in the real space RS is used as a reference position of the three-dimensional measurement. The recognizer 152 recognizes the wall E1 based on the result of the three-dimensional measurement. For example, the recognizer 152 recognizes the vertical plane as the wall E1 based on the result of the three-dimensional measurement. The recognizer 152 decides a distance n from the information processing device 1 to the wall E1 based on the result of the three-dimensional measurement.

The operation controller 153 controls an operation of the information processing device 1. The operation controller 153 provides image data r representing an image to the touch panel 12 to thereby make the touch panel 12 display the image represented by the image data r.

The operation controller 153 makes the touch panel 12 display the first simulation image G1. The operation controller 153 generates simulation image data r1 based on the result of the three-dimensional measurement and the imaging data kt. The simulation image data r1 is an example of the image data r. The simulation image data r1 represents the first simulation image G1.

For example, the operation controller 153 decides a size q of the sample image J1 based on the distance n decided from the result of the three-dimensional measurement. The distance n is a distance from the information processing device 1 to the wall E1. The size q of the sample image J1 represents the length in a lateral direction of the sample image J1 and the length in a longitudinal direction of the sample image J1. The operation controller 153 increases the size q in accordance with, for example, an increase in the length n. The operation controller 153 decides a correspondence relationship between the distance n and the size q based on the field angle of the projector 2. The field angle of the projector 2 is described in the program P1. Therefore, the operation controller 153 recognizes the field angle of the projector 2 in advance.

The operation controller 153 decides an image obtained by superimposing the sample image J1 with the size q, and projector image L1, and the path image L2 on the target image H1 as the first simulation image G1.

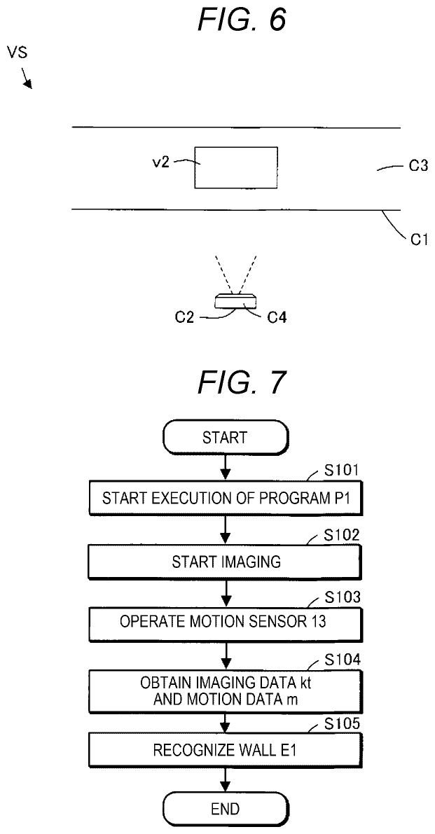

The operation controller 153 decides the sample image J1 using the virtual space VS as a three-dimensional space. FIG. 6 is a diagram showing an example of the virtual space VS.

The operation controller 153 uses the virtual space VS to thereby reproduce the arrangement of the object in the real space RS.

The operation controller 153 uses the result of the three-dimensional measurement with respect to the wall E1 to thereby set a first position C1 in the virtual space VS. The first position C1 in the virtual space VS corresponds to a position of the wall E1 in the real space RS.

The operation controller 153 decides a shape of a virtual plane C3 based on the result of the three-dimensional measurement with respect to the wall E1. The virtual plane C3 has substantially the same shape as that of the wall E1. The virtual plane C3 is a plane corresponding to the wall E1. The operation controller 153 disposes the virtual plane C3 at the first position C1.

The operation controller 153 sets a second position C2 in the virtual space VS based on a position of the camera 11 in the real space RS. The second position C2 in the virtual space VS corresponds to the position of the camera 11 in the real space RS. The camera 11 is located in the information processing device 1 together with the touch panel 12. Therefore, the second position C2 in the virtual space VS corresponds to a position of the camera 11 in the real space RS, and at the same time, corresponds to a position of the touch panel 12 in the real space RS.

The operation controller 153 disposes a virtual projector C4 at the second position C2. Therefore, in the virtual space VS, a relative position of the virtual projector C4 to the second position C2 is fixed. In the virtual space VS, the state in which the relative position of the virtual projector C4 to the second position C2 is fixed is not limited to the state in which the virtual projector C4 is located at the second position C2. For example, in the virtual space VS, it is possible for the relative position of the virtual projector C4 to the second position C2 to be fixed in the state in which the virtual projector C4 is located at a position different from the second position C2.

The second position C2 changes in accordance with the change in position of the touch panel 12 in the real space RS. Therefore, in the situation in which the relative position of the virtual projector C4 to the second position C2 is fixed in the virtual space VS, when the position of the touch panel 12 in the real space RS changes, the position of the virtual projector C4 changes in the virtual space VS.

The virtual projector C4 is a projector corresponding to the projector 2. Specifications of the virtual projector C4 are substantially the same as specifications of the projector 2. The specifications of the projector 2 are described in the program P1. Therefore, the operation controller 153 recognizes the specifications of the projector 2 in advance.

The operation controller 153 makes the orientation of the optical axis of a projection lens of the virtual projector C4 with respect to the virtual plane C3 coincide with the orientation of the optical axis of the imaging lens 111 with respect to the wall E1. It should be noted that the operation controller 153 decides the orientation of the optical axis of the imaging lens 111 with respect to the wall E1 based on the recognition result of the wall E1 and the motion data m.

The operation controller 153 disposes a screen image v2 on the virtual plane C3. The screen image v2 is an image obtained by viewing an image, which is displayed on the virtual plane C3 in the situation in which the virtual projector C4 projects the image on the virtual plane C3, from the second position C2. The screen image v2 is another example of the first display image. The screen image v2 is an image showing a region in which the sample image J1 is displayed. The screen image v2 functions as a screen of the sample image J1. A size of the screen image v2 is equal to the size q of the sample image J1. The operation controller 153 decides the size of the screen image v2 using a method substantially the same as the method of deciding the size q of the sample image J1. The screen image v2 is an image corresponding to the projection image F1.

The position of the screen image v2 in the virtual plane C3 is fixed in accordance with an instruction from the user. Until the instruction is obtained from the user, the operation controller 153 decides the position of the screen image v2 in the virtual plane C3 based on a position of an intersection between the virtual plane C3 and the optical axis of the projection lens of the virtual projector C4. For example, the operation controller 153 conforms a central position of the screen image v2 in the virtual plane C3 to the position of the intersection between the virtual plane C3 and the optical axis of the projection lens of the virtual projector C4. The central position of the screen image v2 is, for example, a position of an intersection of diagonal lines in the screen image v2.

The operation controller 153 changes the screen image v2 to the sample image J1 to thereby decide the first simulation image G1.

The sample image J1 is an image obtained by viewing an image, which is displayed on the virtual plane C3 in the situation in which the image is projected on the virtual plane C3 from the virtual projector C4 the relative position to the second position C2 of which is fixed, from the second position C2.

In the situation in which the relative position of the virtual projector C4 to the second position C2 is fixed in the virtual space VS, when the position of the touch panel 12 in the real space RS changes, a position of a viewpoint from which the image displayed on the virtual plane C3 is viewed changes in addition to the position of the virtual projector C4 in the virtual space VS.

The operation controller 153 generates the simulation image data r1 representing the first simulation image G1.

The operation controller 153 provides the touch panel 12 with the simulation image data r1 to thereby make the touch panel 12 display the first simulation image G1.

### A3: Recognition of Wall E1

FIG. 7 is a flowchart for explaining an operation of recognizing the wall E1.

When the touch panel 12 has received a start-up instruction from the user, the processing device 15 starts execution of the program P1 as an application program in the step S101.

Subsequently, in the step S102, the operation controller 153 makes the camera 11 start imaging of the target region TR. The camera 11 images the target region TR to thereby generate the imaging data kt.

Subsequently, in the step S103, the operation controller 153 makes the motion sensor 13 operate. The motion sensor 13 generates the motion data m.

Subsequently, in the step S104, the acquirer 151 starts acquisition of the imaging data kt and the motion data m.

Subsequently, in the step S105, the operation controller 153 makes the recognizer 152 recognize the wall E1.

In the step S105, the recognizer 152 executes the three-dimensional measurement with respect to the object existing in the target region TR based on the imaging data kt and the motion data m obtained by the acquirer 151 in a scanning situation.

The scanning situation means the situation in which the information processing device 1 is moved from the first point to the second point while the camera 11 is imaging the wall E1. The first point is, for example, a position of the information processing device 1 at the starting point of the scanning situation. The second point is, for example, a position of the information processing device 1 at the ending point of the scanning situation. The imaging data kt obtained by the acquirer 151 in the scanning situation corresponds to the first imaging data k1 and the second imaging data k2. The first imaging data k1 corresponds to the imaging data kt which is generated by the camera 11 when the information processing device 1 is located at the first point. The second imaging data k2 corresponds to the imaging data kt which is generated by the camera 11 when the information processing device 1 is located at the second point. The motion data m obtained by the acquirer 151 in the scanning situation corresponds to the motion data ms. The motion data ms corresponds to the motion data m which is generated by the motion sensor 13 in the situation in which the information processing device 1 is moved from the first point to the second point while the camera 11 is imaging the wall E1.

The recognizer 152 decides the distance from the first point to the second point as the base line length based on the motion data ms. The recognizer 152 executes the triangulation using the base line length, the first imaging data k1, and the second imaging data k2 to thereby execute the three-dimensional measurement.

Subsequently, the recognizer 152 recognizes the wall E1 based on the result of the three-dimensional measurement. For example, the recognizer 152 recognizes the vertical plane as the wall E1 based on the result of the three-dimensional measurement.

### A4: Display of First Simulation Image G1

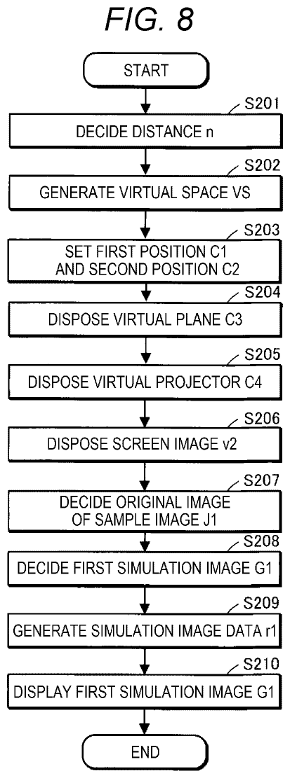

FIG. 8 is a flowchart for explaining an operation of displaying the first simulation image G1. The operation shown in FIG. 8 is executed in the situation in which the wall E1 is recognized.

In the step S201, the operation controller 153 makes the recognizer 152 decide the distance n from the information processing device 1 to the wall E1.

In the step S201, the recognizer 152 first obtains the motion data m from the acquirer 151. Subsequently, the recognizer 152 decides the position of the information processing device 1 in the real space RS, namely the position of the camera 11 in the real space RS, based on the motion data m. Subsequently, the recognizer 152 decides the distance n from the information processing device 1 to the wall E1 based on the result of the three-dimensional measurement and the position of the information processing device 1 in the real space RS.

Subsequently, in the step S202, the operation controller 153 generates the virtual space VS.

Subsequently, in the step S203, the operation controller 153 sets the first position C1 and the second position C2 in the virtual space VS.

In the step S203, the operation controller 153 first uses the result of the three-dimensional measurement with respect to the wall E1 to thereby set the first position C1 in the virtual space VS. The first position C1 in the virtual space VS corresponds to a position of the wall E1 in the real space RS. Subsequently, the operation controller 153 uses the position of the camera 11 in the real space RS to thereby set the second position C2 in the virtual space VS. The second position C2 in the virtual space VS corresponds to the position of the camera 11 in the real space RS.

Subsequently, in the step S204, the operation controller 153 disposes the virtual plane C3 in the virtual space VS.

In the step S204, the operation controller 153 first makes the shape of the virtual plane C3 coincide with the shape of the wall E1 of the virtual plane C3 based on the result of the three-dimensional measurement with respect to the wall E1. Subsequently, the operation controller 153 disposes the virtual plane C3 at the first position C1.

Subsequently, in the step S205, the operation controller 153 disposes the virtual projector C4 at the second position C2.

In the step S205, the operation controller 153 disposes the virtual projector C4 at the second position C2 to thereby fix the relative position of the virtual projector C4 to the second position C2. Subsequently, the operation controller 153 decides the orientation of the optical axis of the imaging lens 111 with respect to the wall E1 based on the recognition result of the wall E1 and the motion data m. Subsequently, the operation controller 153 makes the orientation of the optical axis of the projection lens of the virtual projector C4 with respect to the virtual plane C3 coincide with the orientation of the optical axis of the imaging lens 111 with respect to the wall E1.

Subsequently, in the step S206, the operation controller 153 disposes the screen image v2 on the virtual plane C3.

In the step S206, the operation controller 153 conforms the central position of the screen image v2 in the virtual plane C3 to the position of the intersection between the virtual plane C3 and the optical axis of the projection lens of the virtual projector C4. It should be noted that the central position of the screen image v2 in the virtual plane C3 is not limited to the position of the intersection between the virtual plane C3 and the optical axis of the projection lens of the virtual projector C4, but is only required to be a position based on the position of the intersection. Subsequently, the operation controller 153 decides the size of the screen image v2 based on a decision result of the distance n. The operation controller 153 increases the size of the screen image v2 in accordance with an increase in the distance n. The operation controller 153 decides the correspondence relationship between the distance n and the size of the screen image v2 based on the field angle of the projector 2. Subsequently, the operation controller 153 sets the path of the projection light proceeding from the virtual projector C4 toward the screen image v2 in the virtual space VS. Subsequently, when the touch panel 12 has received a position setting instruction from the user, the operation controller 153 fixes the screen image v2 at the position of the screen v2 when the position setting instruction has been received.

Subsequently, in the step S207, the operation controller 153 decides an original image of the sample image J1. In the step S207, the operation controller 153 first decides the image, which is displayed in the screen image v2 in the virtual plane C3 in the situation in which the image is projected on the screen image v2 in the virtual plane C3 from the virtual projector C4 the relative position to the second position C2 of which is fixed, as the original image of the sample image J1. It should be noted that the size of the original image of the sample image J1 is equal to the size of the screen image v2.

Subsequently, in the step S208, the operation controller 153 decides the first simulation image G1.

In the step S208, the operation controller 153 first changes the screen image v2 to the original image of the sample image J1 in the virtual space VS. Subsequently, the operation controller 153 installs the virtual camera having the same characteristics as the characteristics of the camera 11 at the second position C2. The position of the optical axis of the imaging lens of the virtual camera coincides with the position of the optical axis of the projection lens of the virtual projector C4.

Subsequently, the operation controller 153 deletes the virtual plane C3 from the virtual space VS while leaving the original image of the sample image J1, the virtual projector C4, and the path of the projection light from the virtual projector C4 toward the original image of the sample image J1 in the virtual space VS.

Subsequently, the operation controller 153 decides an image, which is obtained when the virtual camera executes the imaging, as the first image.

The first image has a transmissive property. The first image includes an image obtained when viewing the original image of the sample image J1 from the second position C2. In the first image, the image obtained when viewing the original image of the sample image J1 from the second position C2 becomes the sample image J1.

The first image further includes an image showing the virtual projector C4. In the first image, the image showing the virtual projector C4 is an example of the projector image L1.

The first image further includes an image showing the path of the projection light from the virtual projector C4 toward the original image of the sample image J1. In the first image, an image showing the path of the projection light from the virtual projector C4 toward the original image of the sample image J1 is an example of the path image L2.

Subsequently, the operation controller 153 superimposes the first image on the target image H1 to thereby decide the first simulation image G1.

Subsequently, in the step S209, the operation controller 153 generates the simulation image data r1 representing the first simulation image G1.

Subsequently, in the step S210, the operation controller 153 provides the touch panel 12 with the simulation image data r1 to thereby make the touch panel 12 display the first simulation image G1.

As described above, in the virtual space VS, when the relative position of the virtual projector C4 to the second position C2 is fixed, the operation controller 153 displays the first simulation image G1 in which the sample image J1 is superimposed on the target image H1 on the touch panel 12. The sample image J1 is an image obtained by viewing an image, which is displayed on the virtual plane C3 in the situation in which the virtual projector C4 the relative position to the second position C2 of which is fixed projects the image on the virtual plane C3, from the second position C2.

### A5: Example of Operation

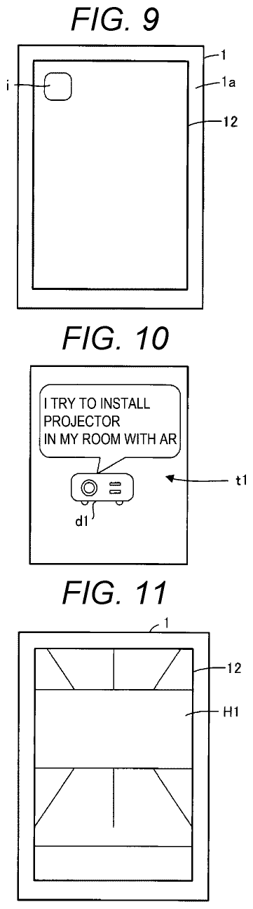

Then, an example of the operation described above will be descried. In the step S101, the processing device 15 starts the execution of the program P1. The step S101 is executed when the touch panel 12 receives a start-up instruction from the user. The start-up instruction is, for example, a tap on an icon i representing the program P1 displayed on the touch panel 12. FIG. 9 is a diagram showing an example of the icon i displayed on the touch panel 12.

When the icon i is tapped, the processing device 15 retrieves the program P1 from the storage device 14. Subsequently, the processing device 15 executes the program P1.

The processing device 15 makes the touch panel 12 display a splash screen until the program P1 is executed. When the processing device 15 executes the program P1, the operation controller 153 makes the touch panel 12 display a first guide image t1.

FIG. 10 is a diagram showing an example of the first guide image t1. The first guide image t1 shows an outline of a function of the information processing device 1 realized by executing the program P1.

For example, the first guide image t1 shown in FIG. 10 shows a projector d1 which makes a comment “I TRY TO INSTALL PROJECTOR IN MY ROOM WITH AR.” AR is an abbreviation of Augmented Reality, and means augmented reality.

The comment shown in the first guide image t1 is not limited to the comment “I TRY TO INSTALL PROJECTOR IN MY ROOM WITH AR” and can arbitrarily be changed. The first guide image t1 is not required to show the projector d1. The first guide image t1 can show an object different from the projector d1 such as an animal instead of the projector d1.

Subsequently, in the step S102, the camera 11 images the target region TR to thereby generate the imaging data kt. Subsequently, in the step S103, the motion sensor 13 generates the motion data m. Subsequently, in the step S104, the acquirer 151 starts the acquisition of the imaging data kt and the motion data m.

After completion of the step S104, it is possible for the operation controller 153 to obtain the imaging data kt from the acquirer 151. In this case, the operation controller 153 provides the touch panel 12 with the imaging data kt as the image data r to thereby make the touch panel 12 display the target image H1. FIG. 11 is a diagram showing an example of the information processing device 1 displaying the target image H1.

Subsequently, in the step S105, the operation controller 153 makes the recognizer 152 recognize the wall E1.

In the step S105, the operation controller 153 first makes the touch panel 12 display an image u1.

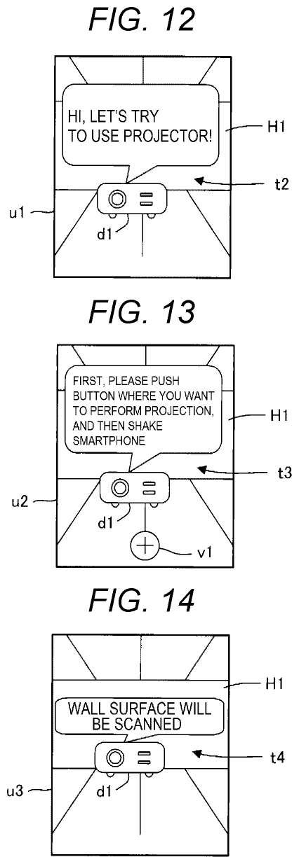

FIG. 12 is a diagram showing an example of the image u1. The image u1 is an image obtained by superimposing a second guide image t2 on the target image H1. The second guide image t2 shows the projector d1 making a comment “HI, LET'S TRY TO USE PROJECTOR!”

The comment shown in the second guide image t2 is not limited to the comment “HI, LET'S TRY TO USE PROJECTOR!” but can arbitrarily be changed. The second guide image t2 is not required to show the projector d1. The second guide image t2 can show an object different from the projector d1 such as an animal instead of the projector d1.

Subsequently, the operation controller 153 makes the touch panel 12 display an image u2.

FIG. 13 is a diagram showing an example of the image u2. The image u2 is an image obtained by superimposing a third guide image t3 and a button v1 on the target image H1. The third guide image t3 is an image which prompts the user to generate the scanning situation. The scanning situation means the situation in which the information processing device 1 is moved from the first point to the second point while the camera 11 is imaging the wall E1. The button V1 is a button for receiving an input of start of the scanning situation.

The third guide image t3 shows the projector d1 making a comment “FIRST, PLEASE PUSH BUTTON WHERE YOU WANT TO PERFORM PROJECTION, AND THEN SHAKE SMARTPHONE.”

The comment shown in the third guide image t3 is not limited to the comment “FIRST, PLEASE PUSH BUTTON WHERE YOU WANT TO PERFORM PROJECTION, AND THEN SHAKE SMARTPHONE,” but can arbitrarily be changed as long as the comment prompts the user to generate the scanning situation. The third guide image t3 is not required to show the projector d1. The third guide image t3 can show an object different from the projector d1 such as an animal instead of the projector d1. The configuration of the button v1 is not limited to the configuration shown in FIG. 13, but can arbitrarily be changed.

In accordance with the comment in the third guide image t3, the user pushes the button v1 in the state in which, for example, the wall E1 is displayed on the touch panel 12, and then shakes the information processing device 1.

When the touch panel 12 has detected the tap on the button v1, the operation controller 153 makes the touch panel 12 display an image u3.

FIG. 14 is a diagram showing an example of the image u3. The image u3 is an image obtained by superimposing a fourth guide image t4 on the target image H1. The fourth guide image t4 shows the projector d1 making a comment “WALL SURFACE WILL BE SCANNED.”

The comment shown in the fourth guide image t4 is not limited to the comment “WALL SURFACE WILL BE SCANNED,” but can arbitrarily be changed. The fourth guide image t4 is not required to show the projector d1. The fourth guide image t4 can show an object different from the projector d1 such as an animal instead of the projector d1.

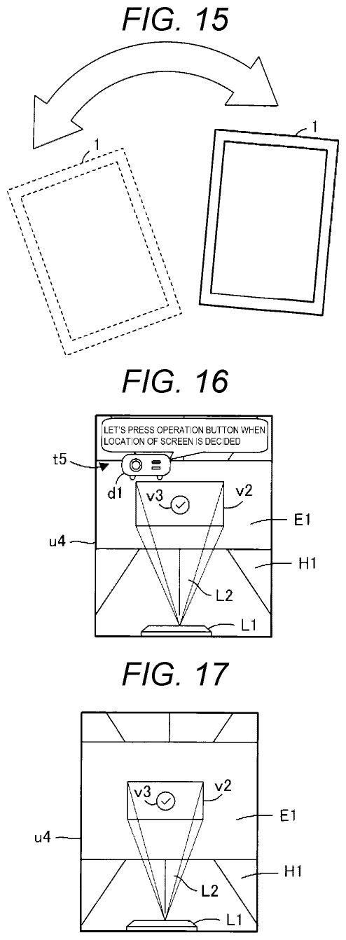

FIG. 15 is a diagram showing a situation in which the information processing device 1 is shaken by the user. When the user shakes the information processing device 1, the scanning situation occurs.

In the scanning situation, the recognizer 152 obtains the first imaging data k1, the second imaging data k2, and the motion data ms.

The recognizer 152 recognizes the wall E1 based on the first imaging data k1, the second imaging data k2, and the motion data ms.

Subsequently, in the step S201, the operation controller 153 makes the recognizer 152 decide the distance n from the information processing device 1 to the wall E1.

Subsequently, in the step S202, the operation controller 153 generates the virtual space VS.

Subsequently, in the step S203, the operation controller 153 sets the first position C1 and the second position C2 in the virtual space VS.

Subsequently, in the step S204, the operation controller 153 disposes the virtual plane C3 in the virtual space VS.

Subsequently, in the step S205, the operation controller 153 disposes the virtual projector C4 in the virtual space VS.

Subsequently, in the step S206, the operation controller 153 disposes the screen image v2 on the virtual plane C3.

In the step S206, the operation controller 153 first conforms the central position of the screen image v2 in the virtual plane C3 to the position of the intersection between the virtual plane C3 and the optical axis of the projection lens of the virtual projector C4.

Subsequently, the operation controller 153 sets the path of the projection light proceeding from the virtual projector C4 toward the screen image v2 in the virtual space VS.

Subsequently, the operation controller 153 installs the virtual camera having the same characteristics as the characteristics of the camera 11 at the second position C2. The position of the optical axis of the imaging lens of the virtual camera coincides with the position of the optical axis of the projection lens of the virtual projector C4.

Subsequently, the operation controller 153 deletes the virtual plane C3 from the virtual space VS while leaving the screen image v2, the virtual projector C4, and the path of the projection light from the virtual projector C4 toward the original image of the sample image J1 in the virtual space VS.

Subsequently, the operation controller 153 decides an image, which is obtained when the virtual camera executes the imaging, as the second image.

The second image has a transmissive property. The second image includes an image obtained when viewing the screen image v2 from the second position C2. In the second image, an image obtained when viewing the screen image v2 from the second position C2 is another example of the first display image.

The second image further includes an image showing the virtual projector C4. In the second image, the image showing the virtual projector C4 is another example of the projector image L1.

The second image further includes an image showing the path of the projection light from the virtual projector C4 toward the screen image v2. In the second image, the image showing the path of the projection light from the virtual projector C4 toward the screen image v2 is another example of the path image L2.

Subsequently, the operation controller 153 superimposes the second image and a fifth guide image t5 on the target image H1 to thereby generate an image u4. The image u4 is another example of the first simulation image. Subsequently, the operation controller 153 makes the touch panel 12 display the image u4.

FIG. 16 is a diagram showing an example of the image u4. In the image u4, the position of the screen image v2 to the wall E1 changes in accordance with each of a change in position of the touch panel 12 in the real space RS and a change in orientation of the touch panel 12 in the real space RS. The touch panel 12 is installed in the information processing device 1. Therefore, the change in position of the touch panel 12 in the real space RS means a change in position of the information processing device 1 in the real space RS. Further, the change in orientation of the touch panel 12 in the real space RS means a change in orientation of the information processing device 1 in the real space RS. Therefore, it is possible for the user to adjust the position of the screen image v2 with the feeling as if the information processing device 1 were the projector 2 by changing each of the position of the information processing device 1 and the orientation of the information processing device 1.

Further, a portion of the wall E1 shown in the target image H1 is changed in accordance with each of the change in position of the touch panel 12 in the real space RS and the change in orientation of the touch panel 12 in the real space RS.

Therefore, when there occurs either one of the change in position of the touch panel 12 in the real space RS and the change in orientation of the touch panel 12 in the real space RS, a portion of the wall E1 shown in the target image H1 in the image u4 is changed on the one hand, but the position of the projector image L1 in the image u4 is not changed on the other hand. Therefore, it is possible for the user to adjust the position of the screen image v2 on the wall E1 with the feeling as if the projector 2 existed at the position of the information processing device 1 by viewing the image u4 displayed on the touch panel 12.

The screen image v2 includes an operation button v3. The operation button v3 is used for fixing the position of the screen image v2 to the wall E1. Furthermore, the operation button v3 is used for the user to input a position setting instruction.

The configuration of the operation button v3 is not limited to the configuration shown in FIG. 16, but can arbitrarily be changed. The color of the screen image v2 having the operation button v3 is gray. The color of the screen image v2 having the operation button v3 is not limited to gray, but can arbitrarily be changed.

The fifth guide image t5 is an image which prompts the user to perform an operation of fixing the position of the screen image v2 to the wall E1. The fifth guide image t5 shows the projector d1 making a comment “LET'S PRESS OPERATION BUTTON WHEN LOCATION OF SCREEN IS DECIDED.”

The comment shown in the fifth guide image t5 is not limited to the comment “LET'S PRESS OPERATION BUTTON WHEN LOCATION OF SCREEN IS DECIDED,” but can arbitrarily be changed as long as the comment prompts the user to perform the operation of fixing the position of the screen image v2. The fifth guide image t5 is not required to show the projector d1. The fifth guide image t5 can show an object different from the projector d1 such as an animal instead of the projector d1.

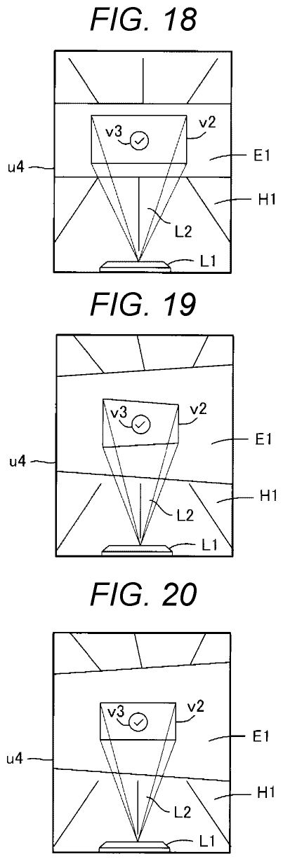

The user confirms the image u4 while changing the position of the information processing device 1. FIG. 17 is a diagram showing an example of the image u4 displayed on the information processing device 1 when the position of the information processing device 1 becomes closer to the wall E1 than the position of the information processing device 1 displaying the image u4 shown in FIG. 16. In FIG. 17, the fifth guide image t5 is omitted. The closer to the wall E1 the information processing device 1 is, the lower the ratio of the size of the screen image v2 to the size of the wall E1 becomes. The size of the screen image v2 shown in FIG. 17 is smaller than the size of the screen image v2 shown in FIG. 18. It should be noted that the size of the screen image v2 shown in the image u4 is not required to be changed.

In order to notify the user of a method of decreasing the ratio of the size of the screen image v2 to the size of the wall E1, it is possible for the operation controller 153 to superimpose the image showing the projector making a comment “THE CLOSER YOU GET, THE SMALLER IT BECOMES” on the image u4. The comment “THE CLOSER YOU GET, THE SMALLER IT BECOMES” is an example of a first operation comment representing an operation of decreasing the ratio of the size of the screen image v2 to the size of the wall E1.

The first operation comment is not limited to the comment “THE CLOSER YOU GET, THE SMALLER IT BECOMES,” but can arbitrarily be changed. As long as the first operation comment is shown, it is not required to show the projector d1 making the first operation comment. The object making the first operation comment is not limited to the projector d1, but can also be an object different from the projector d1 such as an animal.

FIG. 18 is a diagram showing an example of the image u4 displayed on the information processing device 1 when the position of the information processing device 1 becomes farther from the wall E1 than the position of the information processing device 1 displaying the image u4 shown in FIG. 16. In FIG. 18, the fifth guide image t5 is omitted. The farther from the wall E1 the information processing device 1 is, the higher the ratio of the size of the screen image v2 to the size of the wall E1 becomes. The size of the screen image v2 shown in FIG. 18 is larger than the size of the screen image v2 shown in FIG. 16. It should be noted that the size of the screen image v2 shown in the image u4 is not required to be changed.

In order to notify the user of a method of increasing the ratio of the size of the screen image v2 to the size of the wall E1, it is possible for the operation controller 153 to superimpose the image showing the projector making a comment “THE FARTHER YOU GET, THE LARGER IT BECOMES” on the image u4. The comment “THE FARTHER YOU GET, THE LARGER IT BECOMES” is an example of a second operation comment representing an operation of increasing the ratio of the size of the screen image v2 to the size of the wall E1.

The second operation comment is not limited to the comment “THE FARTHER YOU GET, THE LARGER IT BECOMES,” but can arbitrarily be changed. As long as the second operation comment is shown, it is not required to show the projector d1 making the second operation comment. The object making the second operation comment is not limited to the projector d1, but can also be an object different from the projector d1 such as an animal.

It should be noted that it is possible for the operation controller 153 to change the transmittance of the screen image v2 in the image u4 in accordance with the distance n from the information processing device 1 to the wall E1. For example, the operation controller 153 increases the transmittance of the screen image v2 in the image u4 in accordance with an increase in the distance n. In this case, the visibility of the screen image v2 in the image u4 degrades in accordance with an increase in the distance n. Therefore, it is possible for the operation controller 153 to simulate the phenomenon that the visibility of the projection image F1 in the wall E1 degrades in accordance with an increase in distance from the wall E1 to the projector 2.

FIG. 19 is a diagram showing an example of the image u4 displayed on the information processing device 1 when the optical axis of the imaging lens 111 is tilted with respect to a normal line of the wall E1. In this case, the screen image v2 has a distortion corresponding to the tilt of the optical axis of the imaging lens 111 with respect to the normal line of the wall E1. The distortion is called a keystone distortion. When the projector 2 has the distortion correction function of correcting the keystone distortion, the operation controller 153 corrects the keystone distortion of the screen image v2 using the distortion correction function equivalent to the distortion correction function provided to the projector 2. FIG. 20 is a diagram showing an example of the image u4 having the screen image v2 in which the keystone distortion shown in FIG. 19 is corrected. In FIG. 19 and FIG. 20, the fifth guide image t5 is omitted.

When the touch panel 12 has detected the tap on the operation button v3, the operation controller 153 fixes the screen image v2 at the position where the screen image v2 is shown when the operation button v3 is tapped.

Subsequently, the operation controller 153 updates the image u4 into an image u5. For example, the operation controller 153 performs deletion of the operation button v3, a change of the color of the screen image v2 from gray to blue, and addition of a sixth guide image t6 on the image u4 to thereby update the image u4 into the image u5. The color which has been changed of the screen image v2 is not limited to blue, but can arbitrarily be chanted.

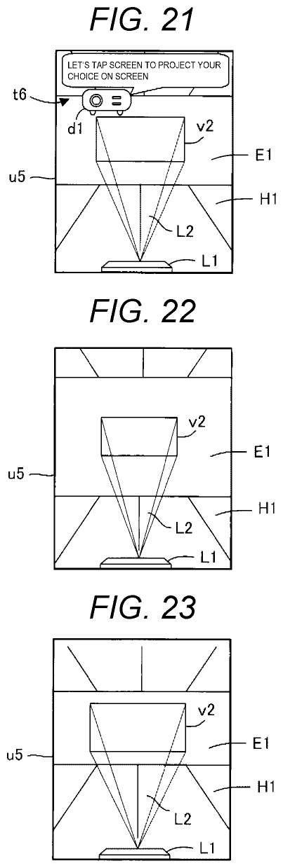

FIG. 21 is a diagram showing an example of the image u5. The image u5 is another example of the simulation image. The sixth guide image t6 in the image u5 is an image which prompts the user to decide the image to be displayed in the screen image v2.

In FIG. 21, the sixth guide image t6 shows the projector d1 making a comment “LET'S TAP SCREEN TO PROJECT YOUR CHOICE ON SCREEN.”

The comment shown in the sixth guide image t6 is not limited to the comment “LET'S TAP SCREEN TO PROJECT YOUR CHOICE ON SCREEN,” but can arbitrarily be changed as long as the comment prompts the user to decide the image to be displayed in the screen image v2. The sixth guide image t6 is not required to show the projector d1. The sixth guide image t6 can show an object different from the projector d1 such as an animal instead of the projector d1.

It is possible for the user to confirm the screen image v2 thus fixed by looking at the image u5 while moving the information processing device 1. FIG. 22 is a diagram showing an example of the image u5 displayed on the information processing device 1 when the position of the information processing device 1 becomes closer to the wall E1 than the position of the information processing device 1 displaying the image u5 shown in FIG. 21. In FIG. 22, the sixth guide image t6 is omitted. In the situation in which the position of the screen image v2 is fixed, the ratio of the size of the screen image v2 to the size of the wall E1 also decreases in accordance with the decrease in distance between the information processing device 1 and the wall E1. The size of the screen image v2 shown in FIG. 22 is smaller than the size of the screen image v2 shown in FIG. 21. It should be noted that the size of the screen image v2 shown in the image u5 can be constant.

It is possible for the operation controller 153 to superimpose an image showing the projector d1 which makes the first operation comment such as “THE CLOSER YOU GET, THE SMALLER IT BECOMES” on the image u5. As long as the first operation comment is shown, it is not required to show the projector d1 making the first operation comment. The object making the first operation comment is not limited to the projector d1, but can also be an object different from the projector d1 such as an animal.

FIG. 23 is a diagram showing an example of the image u5 displayed on the information processing device 1 when the position of the information processing device 1 becomes farther from the wall E1 than the position of the information processing device 1 displaying the image u5 shown in FIG. 21. In FIG. 23, the sixth guide image t6 is omitted. In the situation in which the position of the screen image v2 is fixed, the ratio of the size of the screen image v2 to the size of the wall E1 also increases in accordance with the increase in distance between the information processing device 1 and the wall E1. The size of the screen image v2 shown in FIG. 23 is larger than the size of the screen image v2 shown in FIG. 21. It should be noted that the size of the screen image v2 shown in the image u5 can be constant.

It is possible for the operation controller 153 to superimpose an image showing the projector d1 which makes the second operation comment such as “THE FARTHER YOU GET, THE LARGER IT BECOMES” on the image u5. As long as the second operation comment is shown, it is not required to show the projector d1 making the second operation comment. The object making the second operation comment is not limited to the projector d1, but can also be an object different from the projector d1 such as an animal.

It should be noted that it is possible for the operation controller 153 to change the transmittance of the screen image v2 in the image u5 in accordance with the distance n from the information processing device 1 to the wall E1. For example, the operation controller 153 increases the transmittance of the screen image v2 in the image u5 in accordance with an increase in the distance n.

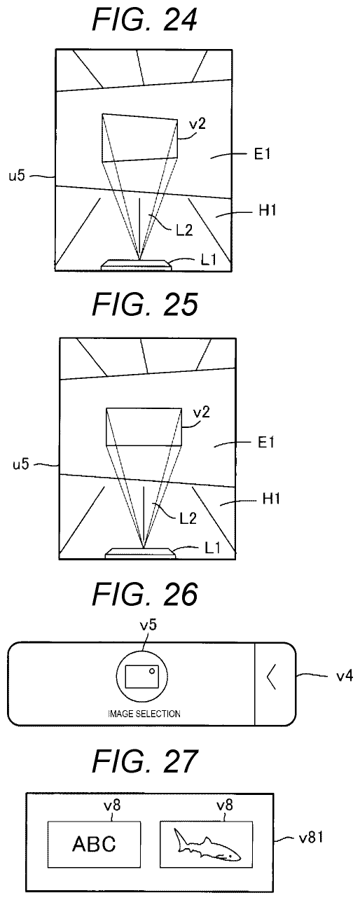

FIG. 24 is a diagram showing an example of the image u5 displayed on the information processing device 1 when the optical axis of the imaging lens 111 is tilted with respect to the normal line of the wall E1. In this case, the screen image v2 has a keystone distortion corresponding to the tilt of the optical axis of the imaging lens 111 with respect to the normal line of the wall E1. When the projector 2 has the distortion correction function of correcting the keystone distortion, the operation controller 153 corrects the keystone distortion of the screen image v2 using the distortion correction function equivalent to the distortion correction function provided to the projector 2. FIG. 25 is a diagram showing an example of the image u5 having the screen image v2 in which the keystone distortion shown in FIG. 24 is corrected. In FIG. 24 and FIG. 25, the sixth guide image t6 is omitted.

It is possible for the user to decide the image to be displayed in the screen image v2 by operating the information processing device 1 in accordance with the sixth guide image t6.

When the touch panel 12 has detected the tap on the screen image v2 in the image u5, the operation controller 153 makes the touch panel 12 display a menu image v4.

FIG. 26 is a diagram showing an example of the menu image v4. The menu image v4 includes a selection button v5.

The selection button v5 is used for deciding an image to be displayed in the screen image v2, namely the sample image J1.

When the touch panel 12 has detected a tap on the selection button v5, the operation controller 153 makes the touch panel 12 display an image v81.

FIG. 27 is a diagram showing an example of the image v81. The image v81 shows candidates v8 of an image to be displayed in the screen image v2. The candidates v8 of the image are each an image corresponding to the projection image F1 projected from the projector 2. For example, the candidates v8 of the image are each an image showing the projection image F1 projected from the projector 2. The candidate v8 of the image is, for example, a photographic image represented by photographic data. The candidate v8 of the image can be an image of a document represented by document data.

The user taps one of the candidates v8 of the image to be used as the sample image J1. When the tough panel 12 has detected the tap on the candidate v8 of the image, the operation controller 153 decides the candidate v8 of the image thus tapped as the sample image J1.

Subsequently, in the step S207, the operation controller 153 decides an original image of the sample image J1. In the step S207, the operation controller 153 changes the size of the sample image J1 into the size of the screen image v2 to thereby decide the original image of the sample image J1.

Subsequently, in the step S208, the operation controller 153 decides the first simulation image G1.

In the step S208, the operation controller 153 changes the screen image v2 to the original image of the sample image J1 in the virtual space VS. Subsequently, the operation controller 153 installs the virtual camera having the same specifications as the specifications of the camera 11 at the second position C2. The position of the optical axis of the imaging lens of the virtual camera coincides with the position of the optical axis of the projection lens of the virtual projector C4.

Subsequently, the operation controller 153 deletes the virtual plane C3 from the virtual space VS while leaving the original image of the sample image J1, the virtual projector C4, and the path of the projection light from the virtual projector C4 toward the original image of the sample image J1 in the virtual space VS.

Subsequently, the operation controller 153 decides an image, which is obtained when the virtual camera executes the imaging, as the first image.

Subsequently, the operation controller 153 superimposes the first image on the target image H1 to thereby decide the first simulation image G1.

Subsequently, in the step S209, the operation controller 153 generates the simulation image data r1 representing the first simulation image G1.

Subsequently, in the step S210, the operation controller 153 provides the touch panel 12 with the simulation image data r1 to thereby make the touch panel 12 display the first simulation image G1.

### A6: Conclusion of First Embodiment

The display method and the information processing device 1 according to the first embodiment include the following aspects.

The acquirer 151 obtains the target image H1 showing the target region TR including the wall E1. In the virtual space VS, when the relative position of the virtual projector C4 to the second position C2 is fixed, the operation controller 153 displays the first simulation image G1 in which the sample image J1 is superimposed on the target image H1 on the touch panel 12. In the virtual space VS, the first position C1 is a position corresponding to the position of the wall E1 in the real space RS. In the virtual space VS, the second position C2 is a position corresponding to the position of the touch panel 12 in the real space RS. The sample image J1 is an image obtained by viewing an image, which is displayed on the virtual plane C3 in the situation in which the image is projected on the virtual plane C3 located at the first position C1 from the virtual projector C4 the relative position to the second position C2 of which is fixed, from the second position C2.

According to this aspect, when the relative position of the virtual projector C4 to the second position C2 is fixed in the virtual space VS, the positional relationship between the virtual projector C4 and the virtual plane C3 changes in accordance with a change in position of the touch panel 12. The sample image J1 is an image obtained by viewing an image, which is displayed on the virtual plane C3 in the situation in which the image is projected on the virtual plane C3 located at the first position C1 from the virtual projector C4 the relative position to the second position C2 of which is fixed, from the second position C2. Therefore, a change in the positional relationship between the virtual projector C4 and the virtual plane C3 is reflected in the appearance of the sample image J1. Therefore, it is possible for the user to recognize the change in the projection image F1 when changing the positional relationship in the real space RS between the projector 2 and the projection image F1 by viewing the change in the sample image J1. Therefore, the convenience is enhanced.

The first simulation image G1 includes the projector image L1 as the image showing the projector 2. The projector image L1 is located in a portion corresponding to the second position C2 in the first simulation image G1. According to this aspect, it is possible for the user to easily imagine the state in which the projector 2 projects the projection image F1 by viewing the state in which the projector shown in the projector image L1 projects the sample image J1.

### B: Modified Examples

Some aspects of the modifications of the embodiment hereinabove illustrated will hereinafter be illustrated. It is also possible to arbitrarily combine two or more aspects arbitrarily selected from the following illustrations with each other within a range in which the aspects do not conflict with each other.

### B1: First Modified Example

In the first embodiment, it is possible for the operation controller 153 to realize the state in which the virtual projector C4 is fixed in the virtual space VS in addition to the state in which the relative position of the virtual projector C4 to the second position C2 is fixed.

When the relative position of the virtual projector C4 to the second position C2 is fixed in the virtual space VS will hereinafter be called a “subjective mode.” In this case, the operation in the first embodiment means an operation in the subjective mode.

Further, when the position of the virtual projector C4 is fixed in the virtual space VS will be called an “overview mode.”

In the subjective mode, the operation controller 153 makes the touch panel 12 display the first simulation image G1.

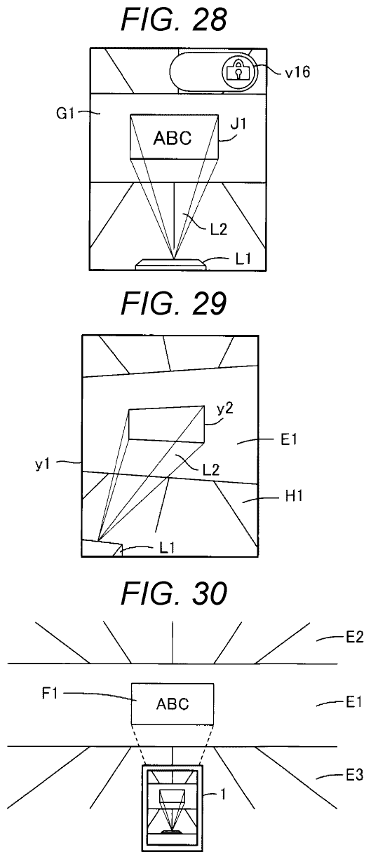

The first simulation image G1 in the first modified example further includes a fixation button v16. FIG. 28 is a diagram showing an example of the first simulation image G1 including the fixation button v16. It is possible for the image u4 and the image u5 to include the fixation button v16.

The fixation button v16 is used by the user to input a fixation instruction of fixing the position of the virtual projector C4 in the virtual space VS. The fixation instruction is an example of an instruction related to display.

In the subjective mode, when the user taps the fixation button v16 to input the fixation instruction to the touch panel 12, the touch panel 12 receives the fixation instruction.

When the touch panel 12 has received the fixation instruction, the operation controller 153 fixes the virtual projector C4 at the position in the virtual space VS of the virtual projector C4 when the touch panel 12 has received the fixation instruction. Subsequently, the operation controller 153 changes the mode from the subjective mode to the overview mode.

In the overview mode, the operation controller 153 makes the touch panel 12 display a second simulation image y1 instead of the first simulation image G1.

In other words, the operation controller 153 makes the touch panel 12 display the first simulation image G1, and then makes the touch panel 12 display the second simulation image y1. Furthermore, when the fixation instruction has been received after making the touch panel 12 display the first simulation image G1, the operation controller 153 makes the touch panel 12 display the second simulation image y1.

FIG. 29 is a diagram showing an example of the second simulation image y1. In the second simulation image y1, a virtual image y2 is superimposed on the target image H1. The virtual image y2 is an image obtained by viewing an image, which is displayed on the virtual plane C3 in the situation in which the virtual projector C4 the position of which is fixed in the virtual space VS projects an image on the virtual plane C3, from the second posit ion C2. The virtual image y2 is an example of a second display image. The virtual projector C4 the position of which is fixed in the virtual space VS means the virtual projector C4 the absolute position of which is fixed in the virtual space VS.

The second simulation image y1 is different from the first simulation image G1 in the point that the virtual image y2 is used instead of the sample image J1, the point that the position of the projector image L1 in the second simulation image y1 changes in accordance with the position of the information processing device 1, and the point that the position of the path image L2 in the second simulation image y1 changes in accordance with the position of the information processing device 1.

A method of deciding the second simulation image y1 is substantially the same as a method of deciding the first simulation image G1 except the point that the touch panel 12 exists at the position of the virtual projector C4 in the virtual space VS when the touch panel 12 has received the fixation instruction. The virtual image y2 is an image corresponding to the projection image F1. The virtual image y2 shows, for example, the projection image F1. The virtual image y2 has predetermined transmittance. The transmittance of the virtual image y2 can be variable.

In the second simulation image y1, the projector image L1 and the path image L2 are superimposed on the target image H1 in addition to the virtual image y2. The projector image L1 is located in a portion corresponding to the position of the virtual projector C4 in the second simulation image y1. In the second simulation image y1, it is possible for the operation controller 153 to delete at least one of the projector image L1 and the path image L2.

The second simulation image y1 can be an image which is obtained by using the virtual image y2 instead of the screen image v2 in the image u4 or the image u5, in which the position of the projector image L1 in the second simulation image y1 changes in accordance with the position of the information processing device 1, and in which the position of the path image L2 in the second simulation image y1 changes in accordance with the position of the information processing device 1.

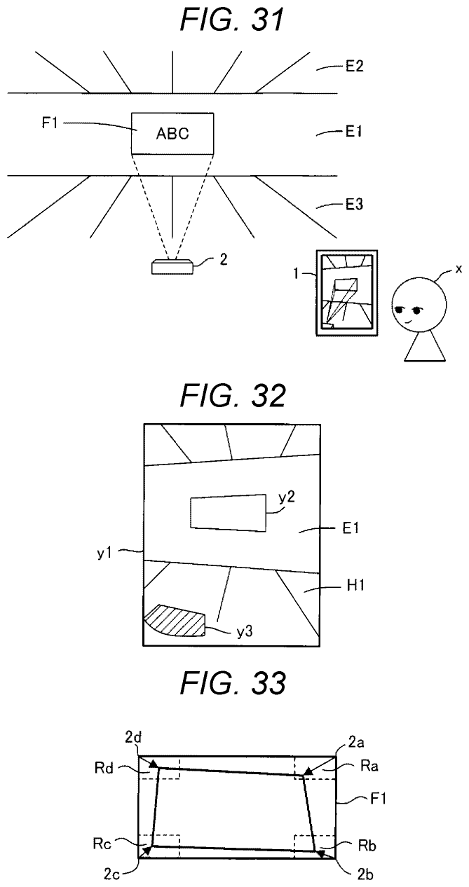

FIG. 30 and FIG. 31 are diagrams for explaining a difference between the subjective mode and the overview mode. FIG. 30 is a diagram for explaining the subjective mode. FIG. 31 is a diagram for explaining the overview mode.

As shown in FIG. 30, in the subjective mode, it is possible for the user to confirm the state of the sample image J1 with the feeling as if the projector 2 were located at the position of the touch panel 12. Therefore, in the subjective mode, it is possible for the user having the touch panel 12 on hand to confirm the state of the sample image J1 with the feeling as if the projector 2 were located by the user. When the user has the feeling as if the projector 2 were located by the user, it is easy for the user to intuitively imagine the state of the projection image F1 based on the state of the sample image J1. Further, in the subjective mode, it is possible for the user to feel a change in position of the touch panel 12 as a change in position of the projector 2. Therefore, when, for example, the user is not used to deciding the installation position of the projector 2, the display of the first simulation image G1 in the subjective mode can help the user decide the installation position of the projector 2.

As shown in FIG. 31, in the overview mode, it is possible for the user x to confirm the state of the sample image J1 with the feeling as if the installation of the projector were completed. Therefore, the display of the second simulation image y1 in the overview mode can help the user x confirm the position of the projector 2 which has been set using the subjective mode.

According to the first modified example, since it is possible to display the first simulation image G1 and the second simulation image y1, it is possible to help the confirmation of the installation position of the projector 2.

The projector image L1 is located in a portion corresponding to the position of the virtual projector C4 in the second simulation image y1. Therefore, it is possible for the user to easily imagine the state in which the projector 2 projects the projection image F1 by viewing the second simulation image y1.

The second simulation image y1 is displayed after displaying the first simulation image G1. Therefore, it is possible for the user to smoothly perform the decision of the installation position of the projector 2 and the confirmation of the result of the decision.

When the fixation instruction has been received after displaying the first simulation image G1, the second simulation image y1 is displayed. Therefore, it is possible for the user to decide the timing of changing the first simulation image G1 to the second simulation image y1 at the timing of inputting the fixation instruction.

### B2: Second Modified Example

In the first embodiment and the first modified example, the position of the virtual projector C4 is limited to a range in which the user can move the information processing device 1. Therefore, in the first modified example, it is possible for the user to change the position of the virtual projector C4 by operating the information processing device 1.

For example, when the projector image L1 is swiped in the second simulation image y1, the operation controller 153 changes the position of the virtual projector C4 in the virtual space VS based on the swipe to the projector image L1. Citing an example, the operation controller 153 changes the position of the virtual projector C4 in the virtual space VS so that the projector image L1 is located at the end position of the swipe.

The operation of changing the position of the virtual projector C4 in the virtual space VS is not limited to the swipe to the projector image L1, but can arbitrarily be changed.

According to the second modified example, it is possible to change the position of the virtual projector C4 with the operation performed by the user.

### B3: Third Modified Example

In the first modified example and the second modified example, it is possible for the operation controller 153 to make the touch panel 12 display the first simulation image G1 subsequently to making the touch panel 12 display the second simulation image y1. For example, in the overview mode, when the touch panel 12 has received a return instruction representing a return to the subjective mode, it is possible for the operation controller 153 to change the overview mode to the subjective mode. In this case, the user can view the first simulation image G1 after the second simulation image y1.

It should be noted that the change from the overview mode to the subjective mode causes a misalignment between the position in the virtual space VS of the virtual projector C4 shown in the second simulation image y1 and the position in the virtual space VS of the virtual projector C4 shown in the first simulation image G1. There is a possibility that the misalignment causes misidentification of the position of the virtual projector C4 to the user. Therefore, in the second modified example, it is possible for the operation controller 153 to stop making the touch panel 12 display the first simulation image G1 subsequently to making the touch panel 12 display the second simulation image y1. In the first modified example, it is possible for the operation controller 153 to stop making the touch panel 12 display the first simulation image G1 subsequently to making the touch panel 12 display the second simulation image y1. It should be noted that when allowing the change from the overview mode to the subjective mode, for example, it is possible for the operation controller 153 to redo the operation started from the recognition of the wall E1.

According to the third modified example, it is possible for the user to effectively use the second simulation image y1 and the first simulation image G1.

### B4: Fourth Modified Example

When the optical axis of the projector 2 has a tilt with respect to the normal line of the wall E1, the projection image F1 displayed on the wall E1 has the keystone distortion corresponding to the tilt.

In the first embodiment, and the first through third modified examples, when the projector 2 has the function of the keystone distortion correction for correcting the keystone distortion, the keystone distortion provided to the projection image F1 displayed on the wall E1 is reduced by the keystone distortion correction.

When the projector 2 has the function of the keystone distortion correction for correcting the keystone distortion, the operation controller 153 adds a function of the keystone distortion correction substantially the same as the function of the keystone distortion correction provided to the projector 2 to the virtual projector C4. In this case, it is possible for the operation controller 153 to make the second simulation image y1 include an image y3 showing a position range of the virtual projector C4 where the virtual projector C4 can correct the shape of the virtual image y2 into a rectangular shape using the keystone distortion correction.

FIG. 32 is a diagram showing an example of the second simulation image y1 including the image y3. When the virtual projector C4 is located at the position shown in the image y3, the virtual projector C4 is capable of correcting the shape of the virtual image y2 into the rectangular shape with the distortion correction function. When the virtual projector C4 is not located at the position shown in the image y3, the virtual projector C4 is not capable of correcting the shape of the virtual image y2 into the rectangular shape.

The operation controller 153 decides the image y3 based on the characteristics of the distortion correction function provided to the virtual projector C4. It should be noted that the position shown in the image y3 is equal to a position where the projector 2 is capable of correcting the shape of the projection image F1 into a rectangular shape with the distortion correction function.

FIG. 33 is a diagram for explaining an example of a keystone distortion correction in the projection image F1. The projection image F1 has a first corner 2a, a second corner 2b, a third corner 2c, a fourth corner 2d, a first range Ra, a second range Rb, a third range Rc, and a fourth range Rd. The first corner 2a, the second corner 2b, the third corner 2c, and the fourth corner 2d constitute the four corners of the projection image F1.

The operation controller 153 individually moves each of the first corner 2a, the second corner 2b, the third corner 2c, and the fourth corner 2d to thereby perform the keystone distortion correction.

The first range Ra is a range in which the first corner 2a can move in accordance with the keystone distortion correction. The second range Rb is a range in which the second corner 2b can move in accordance with the keystone distortion correction. The third range Rc is a range in which the third corner 2c can move in accordance with the keystone distortion correction. The fourth range Rd is a range in which the fourth corner 2d can move in accordance with the keystone distortion correction. The respective sizes of the first range Ra, the second range Rb, the third range Rc, and the fourth range Rd are set in advance.

The first range Ra, the second range Rb, the third range Rc, and the fourth range Rd set a limit of the keystone distortion correction. For example, it is assumed that when the first corner 2a is located between the first range Ra and the second range Rb, the keystone distortion is resolved, and the projection image F1 displayed on the wall E1 becomes to have a rectangular shape. However, when the projector 2 is located outside the range in the real space RS corresponding to the range shown in the image y3, the first corner 2a cannot be located between the first range Ra and the second range Rb, and therefore, it is unachievable to correct the shape of the projection image F1 displayed on the wall E1 into the rectangular shape.

The first range Ra, the second range Rb, the third range Rc, and the fourth range Rd are included in the characteristics of the distortion connection function provided to the projector 2, namely the characteristics of the distortion correction function provided to the virtual projector C4.

The keystone distortion provided to the projection image F1 displayed on the wall E1 depends on the tilt of the optical axis of the projector 2 with respect to the normal line of the wall E1. The degree of the keystone distortion increases in accordance with an increase in the tilt. The tilt of the optical axis of the projector 2 with respect to the normal line of the wall E1 is equal to the tilt of the optical axis of the projector 2 with respect to the normal line of the virtual plane C3. The optical axis of the projector 2 is equal to a straight line passing through the center of the screen image v2 and the second position C2 in the virtual space VS.

The operation controller 153 decides the image y3 based on the characteristics of the distortion correction function provided to the virtual projector C4, the normal line of the virtual plane C3, and the straight line passing through the center of the screen image v2 and the second position C2 in the virtual space VS.

It should be noted that the straight line passing through the center of the screen image v2 and the second position C2 in the virtual space VS is equal to a straight line passing through the center of the sample image J1 and the second position C2 in the virtual space VS. Therefore, it is possible for the operation controller 153 to decide the image y3 based on the characteristics of the distortion correction function provided to the virtual projector C4, the normal line of the virtual plane C3, and the straight line passing through the center of the sample image J1 and the second position C2 in the virtual space VS.

It is possible for the operation controller 153 to use an image showing the first range Ra, the second range Rb, the third range Rc, and the fourth range Rd as the screen image v2.

According to the fourth modified example, it is possible for the user to confirm the position of the virtual projector C4 where shapes of the screen image v2 and the sample image J1 can be corrected into a rectangular shape by viewing the second simulation image y1.

### B5: Fifth Modified Example

In the first embodiment, and the first through fourth modified examples, it is possible for the projector 2 to have an optical zoom lens. In this case, the operation controller 153 adds a virtual optical zoom lens substantially the same as the optical zoom lens provided to the projector 2 to the virtual projector C4. It is possible for the operation controller 153 to change the size of the screen image v2 and the size of the sample image J1 within a range based on a zoom characteristic of the virtual optical zoom lens provided to the virtual projector C4.

For example, when the touch panel 12 has received pinch-in in the situation in which the touch panel 12 displays the screen image v2, the operation controller 153 decreases the size of the screen image v2 within the range based on the zoom characteristic of the virtual optical zoom lens.

When the touch panel 12 has received pinch-out in the situation in which the touch panel 12 displays the screen image v2, the operation controller 153 increases the size of the screen image v2 within the range based on the zoom characteristic of the virtual optical zoom lens.

When the touch panel 12 has received pinch-in in the situation in which the touch panel 12 displays the sample image J1, the operation controller 153 decreases the size of the sample image J1 within the range based on the zoom characteristic of the virtual optical zoom lens.

When the touch panel 12 has received pinch-out in the situation in which the touch panel 12 displays the sample image J1, the operation controller 153 increases the size of the sample image J1 within the range based on the zoom characteristic of the virtual optical zoom lens.

Further, it is possible for the projector 2 to have a digital zoom function. In this case, the virtual projector C4 has substantially the same digital zoom function as the digital zoom function provided to the projector 2. It is possible for the operation controller 153 to change the size of the screen image v2 and the size of the sample image J1 within a range based on a zoom characteristic of the digital zoom function provided to the virtual projector C4. A method of changing the size of the screen image v2 when the virtual projector C4 has the digital zoom function is substantially the same as, for example, the method of changing the size of the screen image v2 when the virtual projector C4 has the virtual optical zoom lens. A method of changing the size of the sample image J1 when the virtual projector C4 has the digital zoom function is substantially the same as, for example, the method of changing the size of the sample image J1 when the virtual projector C4 has the virtual optical zoom lens.

According to the fifth modified example, when the projector 2 has the optical zoom lens or the digital zoom function, it is possible to display the first simulation image G1 corresponding to the zoom function provided to the projector 2.

### B6: Sixth Modified Example

In the first embodiment, and the first through fifth modified examples, it is possible for the projector 2 to have a lens shifting function. In this case, the operation controller 153 adds a lens shifting function substantially the same as the lens shifting function provided to the projector 2 to the virtual projector C4. It is possible for the operation controller 153 to change the position of the screen image v2 and the position of the sample image J1 within a range based on a lens shifting characteristic of the lens shifting function provided to the virtual projector C4.

For example, when the touch panel 12 has received a swipe at the screen image v2, the operation controller 153 moves the screen image v2 in accordance with the swipe within a range based on the lens shifting characteristic of the lens shifting function.

When the touch panel 12 has received a swipe at the sample image J1, the operation controller 153 moves the sample image J1 in accordance with the swipe within a range based on the lens shifting characteristic of the lens shifting function.

According to the sixth modified example, when the projector 2 has the lens shifting function, it is possible to display the first simulation image G1 corresponding to the lens shifting function provided to the projector 2, and the second simulation image y1 corresponding to the lens shifting function provided to the projector 2.

### B7: Seventh Modified Example

In the first embodiment, and the first through sixth modified examples, it is possible for the operation controller 153 to make the touch panel 12 display at least one of the size of the screen image v2, the size of the sample image J1, and the size of the virtual image y2. Further, in the first embodiment, and the first through sixth modified examples, it is possible for the operation controller 153 to make the touch panel 12 display the distance n from the information processing device 1 to the wall E1.

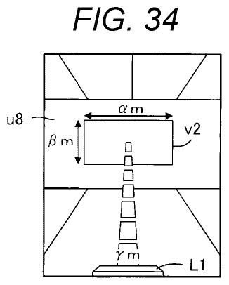

FIG. 34 is a diagram showing an example of the touch panel 12 which displays the size of the screen image v2 and the distance n. The display configuration of the size of the sample image J1 and the display configuration of the size of the virtual image y2 are the same as, for example, the display configuration of the size of the screen image v2. The display configuration of the size of the screen image v2, the display configuration of the distance n, the display configuration of the sample image J1, and the display configuration of the size of the virtual image y2 are not limited to the display configurations shown in FIG. 34, but can arbitrarily be changed.

According to the seventh modified example, it is possible for the user to confirm at least one of the size of the screen image v2, the size of the sample image J1, the size of the virtual image y2, and the distance n by viewing the touch panel 12.

### B8: Eighth Modified Example

In the first embodiment, and the first through seventh modified examples, it is possible to change the projector 2 as an object of the simulation. In this case, in accordance with the change in the projector 2, the operation controller 153 changes the specifications of the virtual projector C4 to the specifications of the projector 2 having been changed. An example of the specifications of the projector 2 is a view angle of the projector 2. An example of the specifications of the virtual projector C4 is a field angle of the virtual projector C4.

The specifications of the projector 2 are not limited to the field angle of the projector 2, but can also be, for example, a brightness of light used by the projector 2 for projecting an image. The specifications of the virtual projector C4 are not limited to the field angle of the virtual projector C4, but can also be, for example, a brightness of light used by the virtual projector C4 for projecting an image.

The operation controller 153 generates the first simulation image G1 based on the specifications of the virtual projector C4 which has been changed. It is possible for the operation controller 153 to generate the second simulation image y1 based on the specifications of the virtual projector C4 which has been changed.

In the first embodiment, and the first through seventh modified examples, it is possible to select the projector 2 as the object of the simulation from a plurality of projectors. In this case, the operation controller 153 changes the specifications of the virtual projector C4 to the specifications of the projector 2 which has been selected, and which is the object of the simulation. The operation controller 153 generates the first simulation image G1 based on the specifications of the virtual projector C4 which has been changed. It is possible for the operation controller 153 to generate the second simulation image y1 based on the specifications of the virtual projector C4 which has been changed.

### B9: Ninth Modified Example

In the first embodiment, and the first through eighth modified examples, the camera 11, the touch panel 12, and the processing device 15 can be made as separated bodies. In the first embodiment, and the first through eighth modified examples, the camera 11 and the touch panel 12 can be separated from the information processing device 1. In the first embodiment, and the first through eighth modified examples, the camera 11 can be separated from the information processing device 1. In the first embodiment, and the first through eighth modified examples, the touch panel 12 can be separated from the information processing device 1. In the first embodiment, and the first through eighth modified examples, the display 121 and the input device 122 can be separated from each other.

What is claimed is:

1. A display method comprising:
obtaining a target image showing a target region including a surface in a real space having the target region and a display; and
displaying a first simulation image on the display, the first simulation image being obtained by superimposing a first display image on the target image, the first display image being obtained by viewing an image from a second position which corresponds to a position of the display in the real space, the image being projected on a virtual plane, which is located at a first position corresponding to a position of the surface in the real space and corresponds to the surface, from a virtual projector when a relative position of the virtual projector to the second position is fixed in a virtual space having the virtual plane and the virtual projector.

2. The display method according to claim 1, wherein
the first simulation image includes a projector image showing the virtual projector, and
the projector image is located in a portion corresponding to the second position in the first simulation image.

3. The display method according to claim 1, wherein
the first simulation image includes an image showing a position range of the virtual projector where the virtual projector is capable of correcting a shape of the first display image into a rectangular shape with a keystone distortion correction.

4. The display method according to claim 1, further comprising:
displaying a second simulation image on the display, the second simulation image being obtained by superimposing a second display image on the target image, the second display image being obtained by viewing an image from the second position, the image being projected on the virtual plane from the virtual projector when an absolute position of the virtual projector is fixed in the virtual space.

5. The display method according to claim 4, wherein
the second simulation image includes a projector image showing a projector, and
the projector image is located in a portion corresponding to a position of the virtual projector in the second simulation image.

6. The display method according to claim 4, wherein
displaying the second simulation image on the display includes displaying the second simulation image on the display after displaying the first simulation image on the display.

7. The display method according to claim 4, wherein
displaying the second simulation image on the display includes displaying the second simulation image on the display when an instruction related to display is received after displaying the first simulation image on the display.

8. The display method according to claim 4, further comprising:
stopping displaying the first simulation image on the display again subsequently to displaying the second simulation image on the display.

9. A display system comprising:
a camera;
a display; and
at least one processor programmed to execute
obtaining a target image showing a target region including a surface in a real space having the target region and the display using the camera, and
controlling the display to display a first simulation image, the first simulation image being obtained by superimposing a first display image on the target image, the first display image being obtained by viewing an image from a second position which corresponds to a position of the display in the real space, the image being projected on a virtual plane, which is located at a first position corresponding to a position of the surface in the real space and corresponds to the surface, from a virtual projector when a relative position of the virtual projector to the second position is fixed in a virtual space having the virtual plane and the virtual projector.
